(19) United States
(12) Patent Application Publication
(10) Pub. No.: US 2003/0121232 A1
(43) Pub. Date: Jul. 3, 2003

(54) Window well cover template system method and apparatus

(76) Inventor: Richard L. Baptist, Fort Collins, CO (US)

Correspondence Address: SANTANGELO LAW OFFICES, P.C., 125 SOUTH HOWES, THIRD FLOOR, FORT COLLINS, CO, 80521, US

(21) Appl. No.: 10/034,956

(22) Filed: Dec. 27, 2001

(51) Int. Cl. E06B 3/30

(52) U.S. Cl. 52/745.2; 52/169.6; 52/200

(57) ABSTRACT

A business method for measuring or manufacturing well covers that allows the use of a template to record the contour of the air terminal of a retaining wall of a window well that can be transported to the manufacturer to provide visual indicia from which well covers can be dimensioned to fit.

### BACKGROUND OF THE INVENTION

Generally this invention relates to a method manufacturing window well covers. Specifically, a window well cover template and methods of generating window well cover templates that provide indicia of the contour of the retaining walls of window wells from which window well covers can be manufactured.

Window wells are earth-retaining structures established around windows that are established below the grade line that intersects the foundation of a structure or building. Pursuant to the 1986 National Building Code, two-foot widow wells became mandatory in any building having a basement with windows. The Code was revised in 1997 mandating a three-foot well. As such, all buildings with basements built after 1986 have window wells.

Window well covers are essential in preventing humans, animals, and other objects or material from falling into or accumulating in window wells. Additionally, window wells protect the homeowner and the community at large by eliminating otherwise convenient hiding places for human and animal intruders.

Accordingly, there is a large and growing commercial market for window well covers. However, even though window wells are required by Code, and even there is large commercial market for window well covers, significant problems remain unresolved in the manufacturing and provision of window well covers.

A significant problem with conventional window well cover technology may be improperly fitting window well covers. There are window well covers that are mass manufactured to fit correspondingly mass manufactured window wells. However, when a window well is installed and backfill is placed against it, the configuration of the window well can be altered and the corresponding mass manufactured window well may not fit properly to the contour of the terminal portion of the window well. Similarly, a window well that is several years old may have shifted out of its original orientation with the window it surrounds and the original window well cover may not fit. Again, some types of mass manufactured window wells or the corresponding mass manufactured window well covers may no longer be available making replacement of damaged window well covers impossible or impractical. Finally, many window wells are built in place, such as poured in place concrete or otherwise built in place from masonry block, wood timber, or the like. These built in place window wells may have a configuration identical to, similar to, or may be of different configuration to those available in the mass market. As to each, a conventional mass market window well cover may not fit or function properly when used.

Another significant problem with conventional window well cover technology may be that it requires a window well cover specialist to come to where the building is located to measure or otherwise establish the configuration or determine the dimensions of the window well cover required. One aspect of this problem is the cost of providing such as specialist for a relatively inexpensive product. This labor cost can be a significant portion of the total cost of manufacturing a window well cover. This is particularly problematic when there may be only one or two window wells in a structure or when window wells are configured differently from one another.

Another significant problem with conventional window well cover technology may be that an appropriate tool for assessment of the contour of the retaining wall of a window well may not be available. Because the retaining wall of a window well often manifests a contour having both straight lines and curves, as well as deformations within these lines, it may be difficult if not impossible indirectly make an accurate rendering of the contour in hardcopy by using conventional measurement tool(s), such as a tape measure.

Another significant problem with conventional window well cover technology may be that conventional materials used to make templates for window well covers are too heavy, too large, or cost too much to transport by conventional courier(s) such as the United States Postal Service, United Parcel Service, or Federal Express, or the like.

As to the above-mentioned problems with conventional window well cover technology, the instant invention addresses each in a practical fashion.

### SUMMARY OF THE PRESENT INVENTION

Accordingly, the broad object of embodiments of the invention can be to provide a business method and devices to provide well covers, including window well covers, that properly fit the retaining wall defining the contour of a well.

Another significant object of embodiments of the invention can be to provide a template that can be used in the field to generate visual indicia of the contour of the air terminal portion of a well retaining wall from which well covers can be manufactured at a distant facility.

Another significant object of embodiments of the invention can be to provide a kit that can be distributed by wholesalers or retailers that allows an individual to order a widow well cover without having the manufacturer come to the location of the well itself.

Another significant object of embodiments of the invention can be to lower the cost of manufacturing a widow well cover.

Naturally, further objects of embodiments of the invention are disclosed in other parts of the description and by the figures.

### BRIEF DESCRIPTION OF THE DRAWINGS

FIG. 1 shows a cross section diagram of a typical widow well.

FIG. 2 is an isometric drawing of an embodiment of the window well template invention.

FIG. 3 is an isometric drawing of an additional embodiment of the window well template invention.

FIG. 4 is an isometric drawing of the invention showing an embodiment of visual indicia generated by use of the invention to record the contour of the air terminal of a retaining element of a well.

FIG. 5 is an isometric drawing showing an embodiment of the invention having a triangular construct to provide additional rigidity.

FIG. 6 shows a kit that can include a template material, instructional material, a shipping label, an order form, and a container into which these elements can be inserted in various permutations and combinations.

### DETAILED DESCRIPTION OF THE PREFERRED EMBODIMENTS

Generally a business method of manufacturing window well covers and devices and methods of generating window well cover templates to provide the contour of window well retaining walls to which such window well covers are to be manufactured.

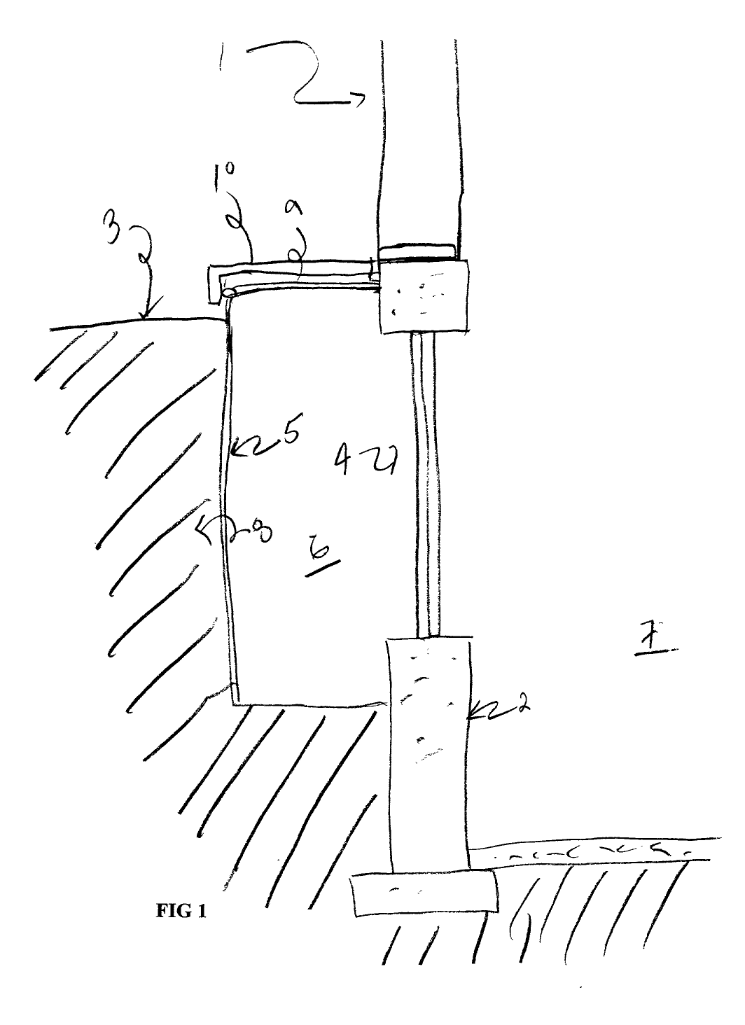

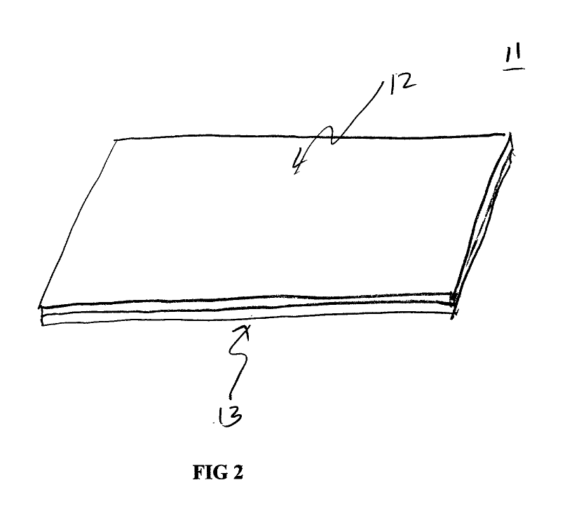

Now referring primarily to FIG. 1, a structure or building (1) having a portion of the foundation (2) exposed below the grade line (3) to accommodate installation of fixtures, fittings, or to expose a portion of the foundation (4) must have a retaining wall (or retaining element) (5) that defines a well (6).

While examples of the invention are provided in the context of residential homes, it should be understood that structures or buildings that the invention can be used with include any structure that has a basement (7) whether residential or commercial of any size or configuration. A well (6) can be excavated below grade line (the level of the earth that intersects the foundation of a structure or building) to expose a portion of the foundation.

The term “window well” can encompass not only a well (6) provided for the placement of windows (as shown by FIG. 1) in the foundation below the grade line (3), but can also encompasses any well (6) that exposes a portion of the foundation for use in a variety of ways, such as, for the provision of storage space, to accommodate the placement of below grade plumbing outlets, electrical outlets, or other types of fittings or fixtures.

The retaining wall (or retaining element) (5) can be made of a variety of materials, such as metal (for example, corrugated sheet metal), masonry block (for example, concrete block, brick, or the like), or other structural material set or poured into place (for example, concrete, or other aggregate material), or can be configured plastic or molded plastic materials. It is understood that the retaining wall (5) can be any material having sufficient structural integrity to define the well (6) against the forces exerted by the backfill (8) against it.

It is to be further understood that the contour or configuration of the retaining wall (or retaining element) (5) can be of any size or shape, including, but not limited to geometries that are square, rectangular, circular, or permutation or combination thereof. The configuration of the retaining wall can in part be conferred by forces of the backfill (6) deforming the retaining wall to some extent or can be conferred by the backfill (8) or the grade line (3) moving or settling deforming or shifting the retaining wall to some extent. As such, it can be understood that the contour of the retaining element (5) can be varied and numerous as selected, or determined by the natural movement of the retaining wall in relation to the backfill or the grade line.

Again, referring primarily to FIG. 1, the retaining wall can have a terminal portion (or air terminal or terminal edge) (9) that can be exposed above the grade line (3). The terminal portion (9) of the retaining wall (or retaining element) has a contour to which the window well cover (10) is typically fitted. As can be understood, the contour of the terminal edge can be as above-described for the retaining wall.

Now referring primarily to FIG. 2, an embodiment of the invention can comprise a window well cover template (11). The window well cover template serves to preserve a record of the contour of the air terminal (9) of the retaining wall so that a window well cover can be manufactured to correspondingly fit. In some embodiments of the invention, a support material (12) having a surface that can be made planar is coupled to an impression retention material (13). However, in some basic embodiments of the invention, the support material (12) and the impression retention material (13) can comprise the opposing surfaces of the same sheet material.

The support material (12) can be made of any material that is or can be made substantially planar. A variety of sheet materials, including, but not limited to, plastic, wood, or press boards (of wood, paper, plastic, or combinations thereof) could be utilized. The support material can also be a material that can be rolled or folded so long as it can be returned to a substantially planar configuration for use. In some embodiments of the invention, the support material can be sheet paper stock having sufficient strength to support the impression retention material (13) during application of compression force(s).

The impression retention material (13) coupled to the support material (12) can, with respect to certain basic embodiments of the invention, be the opposing surface of the support material (12). With respect to other embodiments of the invention the impression retention material (13) can be made of a material compressibly conformable to and capable of retaining an impression of the contour of the air terminal (9) of the retaining wall. The compressibly conformable material can comprise certain foam materials having sufficient air volume to allow indentation of the portion of the foam material compressed against the air terminal and lacking the resiliency to return to a pre-compression conformation, thereby retaining the impression of the contour of the air terminal portion of the retaining element. With respect to basic embodiments of the invention where a compressable material is not utilized for impression retention the impression retention can be accomplished by creating visual indicia with a utensil such as a marker, pencil, scribe, chalk, or other marking means.

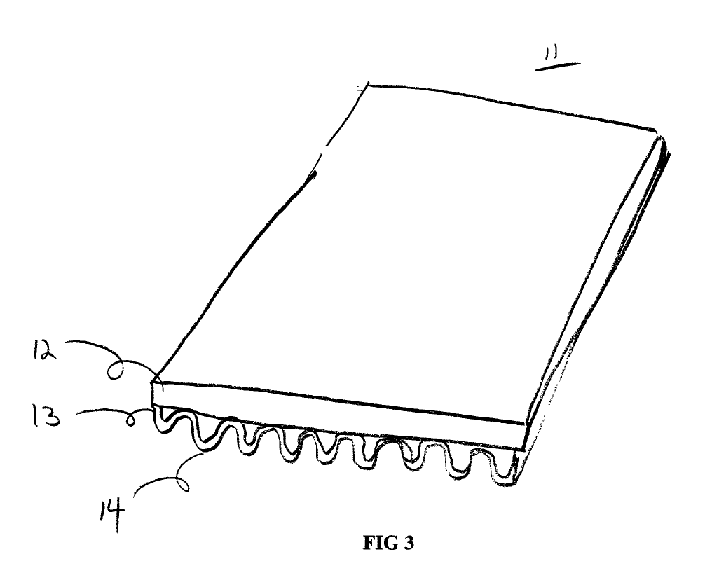

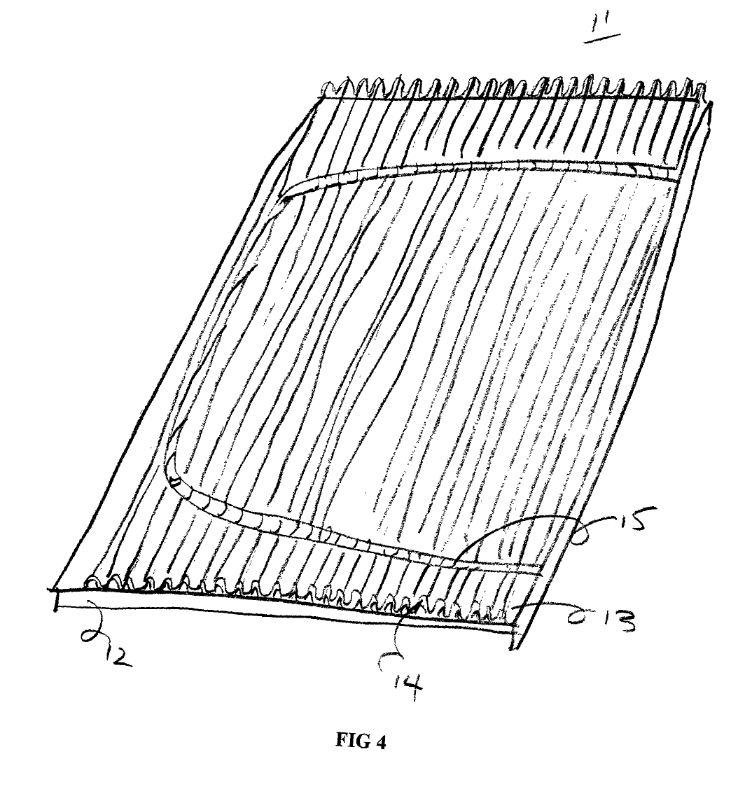

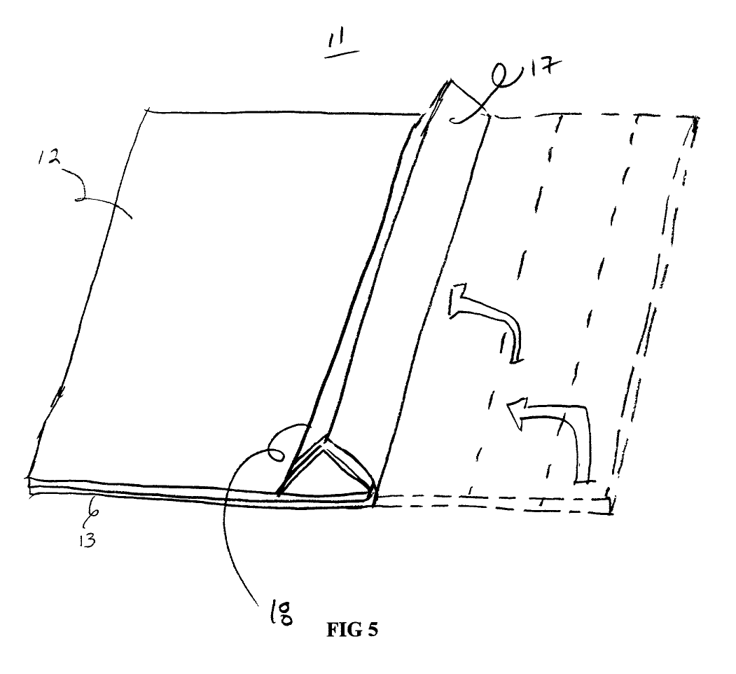

In other embodiments of the invention, the impression retention material (13) can comprise a corrugated material (14) as shown in FIG. 3. With respect to embodiments of the invention utilizing a corrugated material (14), upon compression of the corrugates (14) against the air terminal portion (9) of the retaining element (5), that portion of the corrugates (14) can flatten to some degree toward the support material (12) leaving an indentation (15) having the contour of the air terminal (9) retained after the compressive force is relieved from the impression retention material (13) (14), as shown by FIG. 4.

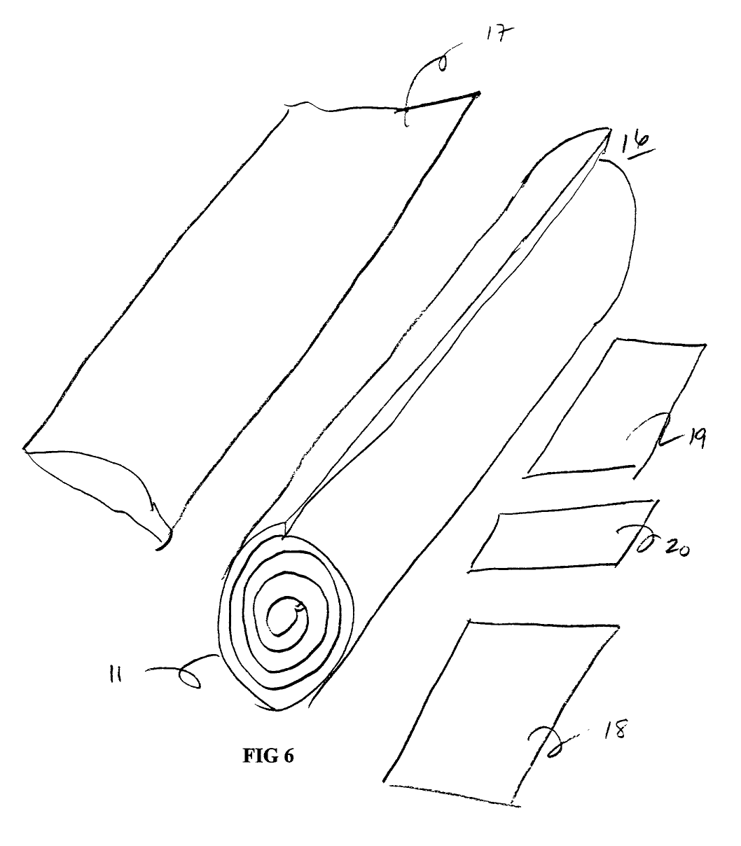

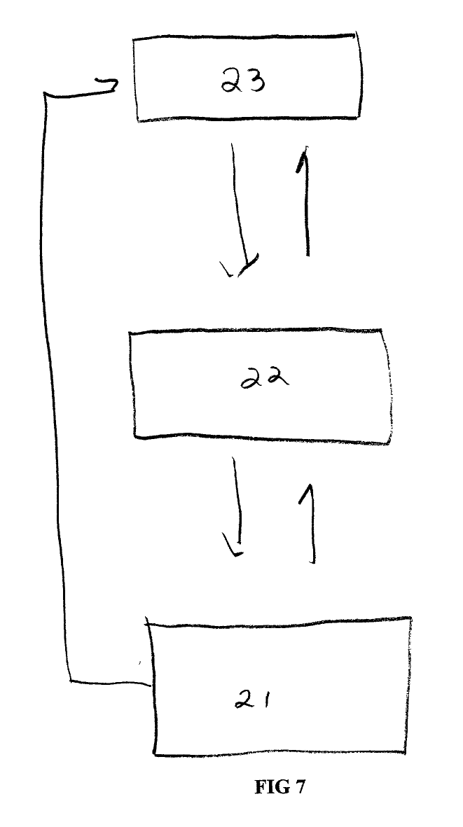

Now referring primarily to FIG. 5, with respect to certain embodiments of the invention the support material (12) or the impression retention material (13) can lack sufficient rigidity to maintain a substantially planer configuration. This may be especially true of embodiments of the invention in which the window well template material (11) is initially established in a rolled configuration (16) for storage or for sale as a kit as shown by FIG. 6. A reinforcement element can be generated that fixes the impressionable surface in a substantially planer configuration by folding the window well template material (11) to establish a triangular construct (17) along an edge of the template material (11). The folded edge (18) of the template material can be joined to the surface of the support material (12) to fix the triangular construct (17). In some embodiments of the invention, the edge (18) of the folded structure can be taped to the surface of the support material (12). The purpose of the taping can be retention of the triangular construct (17) throughout the template making process. Naturally, other geometries for the reinforcement element (17) could be used such as circular or rolled constructs, rectangular constructs, or folding the template material to achieve multiple layers.

Now referring primarily to FIG. 6, certain embodiments of the invention can comprise a kit comprising the window well template material (11) including the support material (12) as described above coupled to an impression retention material (13) as described above. In certain embodiments of the kit the window well template material (11) can be in a rolled configuration (16). In a preferred embodiment of the invention, the rolled configuration of the invention (16) comprises a window well template material (11) having a support material (12) comprising a paper sheet stock coupled to a impression retention surface (13) comprising a corrugated paper. The rolled configuration (16) can be inserted into a container (17). The container with respect to some embodiments of the invention can comprise a clear plastic bag or plastic shrink fitted martial around the rolled configuration (16). Understandably, the container (17) can comprise a variety of containment or packaging elements, as desired including, but not limited to paper or plastic wrapper; paper, plastic, or metal tube; or the like.

The window well cover template kit can further comprise instructions (18) for use of the window well template material and may further comprise an order form (19) to order the manufacture of a window well cover to match the visual indicia provided by the window well cover template (11). Additionally, with respect to certain embodiments of the invention a shipping label (20) can be included in the kit.

Now referring primarily to FIG. 7, a business method or a method of manufacturing a window well cover can comprise a first stage (21) in which the window well template material (11) can be used to record the contour of the air terminal (9) of a retaining element (5) of a well (6) as above-described. The window well template material can be provided for use through wholesale, retail, or direct distribution to the location of the well (6) whether by brick and mortar business entities or by electronic business entities. Different kits may include different sizes of template material (11) for use with differently sized wells (6). The template (11) provided can be sufficiently sized so as be able to cover the entire contour of the air terminal (9) of the retaining wall (or retainer element) (5) that creates the window well or well (6).

The widow well template material can then be positioned so that the impression retention surface (13) is held against the air terminal (9) of the retaining element (5) of the well (6). Visual indicia are generated on the impression retention surface (13) by marking the contour of the air terminal (9) onto the impression retention surface (13) with chalk, pencil, pen, or the like, or by applying compression force to the support surface (12) above the air terminal (9) sufficient to compress the impression retention surface (13) to leave an indentation as shown by FIG. 4.

The second stage (22) of the method of manufacturing can comprise transporting the window well template material or template material (11) having visual indicia on the surface corresponding to the contour of the air terminal (9) to a window well cover manufacturer. In certain embodiments of the invention the transporter can be a separate entity from the user of the template (11) or the manufacturer, such as the United States Postal Service, Federal Express, United Parcel Service, or other similar courier. With regard to embodiments of the invention that come as a kit with a shipping label (20), after the template is used to record the contour of the air terminal (9) of the retaining element (5) of the well (6). The template can be established in a rolled configuration (16) inserted into the container (17) and the label (20) affixed to the exterior of the container (17) and deposited with the courier for transportation to the manufacturer. Understandably, in certain embodiments of the invention the user of the template (11) can deliver the template to the manufacturer directly.

The third stage (23) of the method of manufacturing can comprise manufacturing the window well cover or well cover (10) using the visual indicia on the template (11) that correspond to the contour of the air terminal (9) of the retaining element (5) of the well (6). The constructed window well cover or well cover (10) can then be transported back to the location of the well (6) for installation.

As can be easily understood from the foregoing, the basic concepts of the present invention may be embodied in a variety of ways. It involves, among other aspects, both methods and devices to accomplish the methods, as well as products produced by certain methods. In this application, the methods are disclosed as part of the results shown to be achieved by the various devices described and as steps that are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this application is intended to serve as a basic description. The reader should be aware that the specific discussion may not explicitly describe all embodiments possible; many alternatives are implicit. It also may not fully explain the generic nature of the invention and may not explicitly show how each feature or element can actually be representative of a broader function or of a great variety of alternative or equivalent elements. Again, these are implicitly included in this disclosure. Where the invention is described in device-oriented terminology, each element of the device implicitly performs a function. Apparatus claims may not only be included for the device described, but also method or process claims may be included to address the functions the invention and each element performs. Neither the description nor the terminology is intended to limit the scope of the claims.

It should also be understood that a variety of changes can be made without departing from the essence of the invention. Such changes are also implicitly included in the description. They still fall within the scope of this invention. A broad disclosure encompassing both the explicit embodiment(s) shown, the great variety of implicit alternative embodiments, and the broad methods or processes and the like are encompassed by this disclosure. The patent application is designed to yield a patent cover numerous aspects of the invention both independently and as an overall system.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of a “cover” should be understood to encompass disclosure of the act of “covering”—whether explicitly discussed or not—and, conversely, were there effectively disclosure of the act of “covering”, such a disclosure should be understood to encompass disclosure of a “cover” and even a “means for covering” Such changes and alternative terms are to be understood to be explicitly included in the description.

Any acts of law, statutes, regulations, or rules mentioned in this application for patent; or patents, publications, or other references mentioned in this application for patent are hereby incorporated by reference. In addition, as to each term used it should be understood that unless its utilization in this application is inconsistent with such interpretation, common dictionary definitions should be understood as incorporated for each term and all definitions, alternative terms, and synonyms such as contained in the Random House Webster's Unabridged Dictionary, second edition are hereby incorporated by reference. Finally, all references listed in any information statement filed with the application are hereby appended and hereby incorporated by reference, however, as to each of the above, to the extent that such information or statements incorporated by reference might be considered inconsistent with the patenting of this/these invention(s) such statements are expressly not to be considered as made by the applicant(s).

Thus, the applicant(s) should be understood to claim at least: i) each of the template materials as herein disclosed and described, ii) the related methods or business methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, and ix) methods and apparatuses substantially as described hereinbefore and with reference to any of the accompanying examples, x) the various combinations and permutations of each of the elements disclosed, and xi) each potentially dependent claim or concept as a dependency on each and every one of the independent claims or concepts presented.

In this regard it should be understood that for practical reasons and so as to avoid adding potentially hundreds of claims, the applicant may eventually present claims with initial dependencies only. Support should be understood to exist to the degree required under new matter laws—including but not limited to United States Patent Law 35 U.S.C §32 or other such laws—to permit the addition of any of the various dependencies or other elements presented under one independent claim or concept as dependencies or elements under any other independent claim or concept.

Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible.

I claim:

1. A method of manufacturing a window well cover, comprising the steps of:
(a) providing a template material having a surface;
(b) positioning said surface of said template material on at least a portion of a terminal element coupled to a retaining element of a window well;
(c) generating visual indicia on said surface of said template material corresponding to the contour of said terminal element of said retaining element;
(d) transporting said template material having visual indicia on said surface corresponding to said contour of said terminal element to a window well cover manufacturer; and
(e) manufacturing said window well cover using said visual indicia of said contour of said terminal element as a template.

2. A method of manufacturing a window well cover as described in claim 1, further comprising the step of coupling a conformable material to said surface of said template material, wherein said conformable core material compresses in response to pressure.

3. A method of manufacturing a window well cover as described in claim 2, wherein said step of generating visual indicia on said surface of said template material corresponding to the contour of said terminal element of said retaining element comprises compressing said conformable core material coupled to said surface of said template material leaving an impression of said terminal element on said conformable core material.

4. A method of manufacturing a window well cover as described in claim 3, corrugating said conformable core material.

5. A method of manufacturing a window well cover as described in claim 1, further comprising the step of reducing the exterior surface area of said template.

6. A window well cover manufacturing business as described in claim 1, wherein said step of transporting said template material to a window well cover manufacturer comprises transporting said template material by a courier selected from the group consisting of United States Postal Service, United Parcel Service, and Federal Express.

7. A method of manufacturing a window well cover as described in claim 1, further comprising the step of transporting said window well cover to an installation location.

8. A method of manufacturing a window well cover as described in claim 1, wherein said step of transporting said window well cover to an installation location comprises transporting said window well cover by a courier selected from the group consisting of United States Postal Service, United Parcel Service, and Federal Express.

9. A kit for a window well cover template, comprising:
a. a support material having a planar surface;
b. a impression retention material coupled to said planar surface of said support material conformably responsive to compression forces;

10. A window well cover template as described in claim 9, where in said impression retention material further comprises a corrugated surface.

11. A window well cover template as described in claim 10, further comprising window well template instructions.

12. A window well cover template as described in claim 11, further comprising a window well cover order form.

13. A window well cover template as described in claim 12, further comprising at least one window well cover template shipping label.

14. A window well cover template as described in claim 13, further comprising a container to hold components of said kit for a window well cover template selected from the group consisting of a window well template, template instructions, window well cover order form, and window well cover shipping label.

15. A window well cover template as described in claim 14, wherein said widow well template rolls into a cylindrical configuration, and wherein said container comprises a plastic sleeve configured to hold said cylindrical configuration of said window well template.

16. A method of generating a template for a window well cover, comprising the steps of:
a. providing a template material having an impression retention surface;
b. joining said impression retention surface with at least a portion of a terminal portion of a window well retaining element having a contour;
c. applying pressure to said template material; and
d. creating an impression corresponding to a said contour of said terminal portion of said window well retaining element;.

17. A method of generating a template for a window well cover as described in claim 16, further comprising the step of configuring said template material to generate a reinforcement element that fixes said impressionable surface in a substantially planar configuration.

18. A method of generating a template for a window well cover as described in claim 16, wherein said step of providing a template material having an impressionable surface comprises providing a rolled template material having an impressionable surface.

19. A method of generating a template for a window well cover as described in claim 16, further comprising the step of corrugating said impressionable surface.

20. A method of generating a template for a window well cover as described in claim 17, wherein said step of configuring said template material to generate a reinforcement element that fixes said impressionable surface in a substantially planar configuration comprises folding said template material to establish a triangle along an edge of said template material.
